(19) United States
(12) Patent Application Publication
(10) Pub. No.: US 2014/0217204 A1
(43) Pub. Date: Aug. 7, 2014

(54) FUEL INJECTOR SOLENOID AND TERMINAL ASSEMBLY

(71) Applicants: Bharath Chandrashekar, Columbia, SC (US); Erik Jordan Hansen, Elgin, IL (US); Kasargod Anil Shenoy, Colombus, SC (US); Martin Heiner Luedicke, Colombus, SC (US); Charles kowalczyk, Spartanburg, SC (US)

(72) Inventors: Bharath Chandrashekar, Columbia, SC (US); Erik Jordan Hansen, Elgin, IL (US); Kasargod Anil Shenoy, Colombus, SC (US); Martin Heiner Luedicke, Colombus, SC (US); Charles kowalczyk, Spartanburg, SC (US)

(73) Assignee: Inernational Engine Intellectual Property Company, LLC, Lisle, IL (US)

(21) Appl. No.: 14/343,485

(22) PCT Filed: Jun. 29, 2012
(86) PCT No.: PCT/US12/44872

§ 371 Date: Mar. 7, 2014

Related U.S. Application Data
(60) Provisional application No. 61/532,134, filed on Sep. 8, 2011.

(51) Int. Cl. F02M 51/00; H01R 43/26; H01R 13/46; F02M 51/06

(52) U.S. Cl. CPC F02M 51/005; F02M 51/061; H01R 43/26; H01R 13/46
USPC 239/585.5; 239/585.1; 29/825; 439/625

(57) ABSTRACT

In one embodiment, a fuel injector assembly is described. The fuel injector assembly includes a terminal assembly that electrically connects a plurality of wire cables to a plurality of control valve solenoids. The control valve solenoids can include, for example, a needle control valve solenoid and/or an intensifier control valve solenoid. The terminal assembly can be physically configured with a radius profile that prevents excessive bending of the wire cables. A connector bridge may allow for the offsetting of a first pair and a second pair of electrical rods that are used to provide electrical current from the terminal assembly to the needle control valve solenoid. Alternatively, the intensifier control valve solenoid may have an aperture, and an armature of an associated poppet valve may have a slot, that are configured to receive the placement of at least a portion of the pair of electrical rods.

### RELATED APPLICATIONS

The present application claims priority to U.S. Patent Application No. 61/532,134, having a filing date of Sep. 8, 2011, which is incorporated herein by reference in its entirety.

### BACKGROUND

High-pressure fuel injection systems are often used in combustion engines to deliver fuel, such as diesel fuel or gasoline, to a combustion engine. In such systems, fluid is supplied at high-pressure through a common rail to each of a series of unit fuel injectors within the cylinder head. Each injector includes a valve, such as a needle valve, which controls the release of fuel from the fuel injector. When a needle of the needle valve is lifted to an open position, the fuel is forced out of a small opening or outlet in a nozzle assembly of the fuel injector under high pressure, thereby typically atomizing the fuel that is delivered to the combustion chamber of the combustion engine.

High-pressure fuel injectors may include an intensifier control valve that is electronically controlled by a solenoid that controls the flow of fuel into a pressurization chamber of the fuel injector. When the electronically controlled intensifier control valve is open, a flow path may be open that allows fuel to flow into the pressurization chamber and beneath a plunger. High pressure fuel injectors may also include a second solenoid that is used to control a needle control valve. The needle control valve may be used to drain or remove fuel that is present above the needle of the needle valve, thereby allowing the pressure of the fuel beneath the needle to lift the needle from a valve seat, and thereby allow fuel to flow out of the fuel injector and into the combustion chamber.

Typically, injectors use individual terminal rods for each terminal of the solenoid associated with the needle control valve. The terminal rods may house wiring or a conductor that is used to supply electrical current used to activate the solenoid, as well as insulation material to prevent, or minimize, the potential for an electrical shortage. These individual terminal rods may be terminated at the solenoid through the use of machined screws. Alternatively, a direct electrical contact may be established between terminals of the solenoid and cable wires.

### SUMMARY

Some embodiments relate to a solenoid and terminal assembly of a fuel injector, for example.

In one embodiment, a terminal assembly in a fuel injector is provided. The terminal assembly can include, for example, a connector that electrically connects a plurality of wire cables to a plurality of control valve solenoids. The connector can be configured with a radius profile that prevents excessive bending of the wire cables.

In another embodiment, a fuel injector assembly is provided. The fuel injector assembly can include, for example, a terminal assembly that electrically connects a plurality of wire cables to a plurality of control valve solenoids. The terminal assembly can be configured with a radius profile that prevents excessive bending of the wire cables.

In another embodiment, a fuel injector assembly is provided that includes a terminal assembly having first and second pairs of terminal studs and an intensifier control valve solenoid. The assembly further includes a pair of intensifier control valve electrical rods that terminate at the first pair of terminal studs. The pair of intensifier control valve electrical rods is configured to deliver electrical current to the intensifier control valve solenoid. Additionally, the assembly includes a first pair and a second pair of electrical rods that are electrically coupled together by a connector bridge. The connector bridge is configured to offset the first pair electrical rods from the second pair of electrical rods. Additionally, the second pair of electrical rods is configured to terminate at the second pair of terminal studs, while the first pair of electrical rods is configured to terminate at a needle control valve solenoid.

In an additional embodiment, a fuel injector assembly is provided that includes a pair of electrical rods that are configured to deliver an electrical current to a needle control valve solenoid. The assembly also includes an intensifier control valve solenoid that has a solenoid material. The solenoid material is configured to allow at least a portion of the pair of electrical material rods to pass through the solenoid material. The assembly further includes a poppet valve that has an armature. The armature is configured to be moved between an open position and a closed position by actuation of the intensifier control valve solenoid. Additionally, the armature includes a slot that is configured to receive at least a portion of the pair of electrical rods.

In another embodiment, a method for terminating a solenoid in a fuel injection assembly is described. The first ends of a plurality of electrical rods are electrically connected with first interfaces of a connector bridge. The second ends of the plurality of electrical rods are electrically connected to the solenoid. The second interfaces of the connector bridge are offset such that the offset second interfaces are disposed on an opposite side of the connector bridge as the first interfaces. The second interfaces of the connector bridge are electrically connected to a terminal assembly.

### BRIEF DESCRIPTION OF THE DRAWINGS

FIG. 1 illustrates a perspective view of an embodiment of a solenoid and terminal assembly.

FIG. 2 illustrates a perspective view of an embodiment of a solenoid and terminal assembly.

FIG. 3 illustrates an embodiment of a needle control valve (NCV) solenoid assembly shown in FIG. 1.

FIG. 4 illustrates a close up of the NCV solenoid assembly shown in FIG. 3.

FIG. 5 illustrates an embodiment the NCV solenoid assembly shown in FIG. 2.

FIG. 6 illustrates a close up of the NCV solenoid assembly shown in FIG. 5.

FIG. 7 illustrates a close up of a connection between a pair of electrical rods and the NCV solenoid assembly shown in FIG. 5.

FIG. 8 illustrates an embodiment of a connector bridge that couples the NCV solenoid assembly and the terminal assembly.

FIG. 9 illustrates a cross-section of an embodiment of a connector bridge positioned in a fuel injector in which connector rods are part of the terminal assembly structure rather than part of the connector bridge structure.

FIG. 10 illustrates a perspective view of the connector bridge shown in FIG. 9.

FIG. 11 illustrates a bottom perspective view of an embodiment of a solenoid and terminal assembly including a poppet valve having an armature configured for an in-line electrical connection for the NCV solenoid wires.

FIG. 12 illustrates an embodiment of a wire cable post connecting a wire cable and a connector.

FIG. 13 illustrates a cross-section of the wire cable post connecting the wire cable and the connector shown in FIG. 12.

FIG. 14 illustrates an embodiment of the connector shown in FIG. 12.

FIG. 15 illustrates an embodiment of connectors interfacing with the intensifier control valve (ICV) solenoid assembly.

FIG. 16 illustrates a cross section of the connector shown in FIG. 15.

FIG. 17 illustrates an embodiment of the connector shown in FIG. 15.

FIG. 18 illustrates a terminal assembly engaging with a connector bridge.

FIG. 19 illustrates a radium profile of the terminal assembly shown in FIG. 18.

FIG. 20 illustrates a wiring configuration for a staggered terminal assembly.

FIG. 21 illustrates a terminal assembly with staggered connectors for connection with the engine wiring harness with captured nuts.

FIG. 22 illustrates a terminal assembly and ICV solenoid having a solenoid housing.

FIG. 23 illustrates an NCV solenoid having a NCV solenoid housing.

FIG. 24 illustrates a terminal assembly and ICV solenoid in which the solenoid housing and the terminal housing are made of the same solenoid material.

FIG. 25 illustrates solenoid material being used for the construction of the NCV solenoid and the NCV solenoid housing.

### DETAILED DESCRIPTION

Some embodiments relate to a solenoid and terminal assembly of a fuel injector (e.g., a diesel fuel injector).

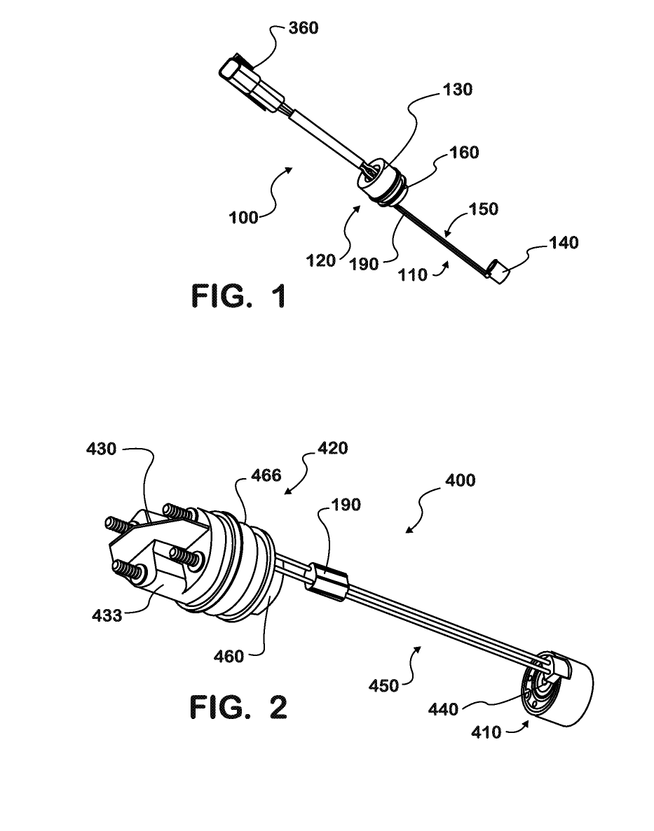

FIG. 1 illustrates a perspective view of an embodiment of a solenoid and terminal assembly 100. The solenoid and terminal assembly 100 includes, for example, a needle control valve (NCV) solenoid assembly 110, an intensifier control valve (ICV) solenoid assembly 120, and a terminal assembly 130. The NCV solenoid assembly 110 includes, for example, an NCV solenoid 140 and an NCV solenoid sub-assembly 150.

FIG. 2 illustrates a perspective view of another embodiment of a solenoid and terminal assembly 400. The solenoid and terminal assembly 400 also includes a pole cage assembly 410, an ICV solenoid assembly 420, and a terminal assembly 130. The pole cage assembly 410 includes, for example, an NCV solenoid 440 and an NCV solenoid sub-assembly 450.

The NCV solenoid 140, 440 is coupled to the NCV solenoid sub-assembly 150, 450 which in turn, is coupled to the ICV solenoid assembly 120, 420 which includes an ICV solenoid 160, 460. The ICV solenoid assembly 120, 420 is coupled to the terminal assembly 130, 430. The terminal assembly 130, 430 may be operably coupled to an engine control module (ECM) (not shown), for example, by an engine wiring harness. The NCV solenoid 140, 440 and the ICV solenoid 160, 460 can be electrically coupled to the ECM via the terminal assembly 130, 430. Thus, the terminal of the NCV solenoid 140, 440 and the ICV solenoid 160, 460 completes an electrical circuit with the ECM. The ECM can monitor and/or control the NCV solenoid 140, 440 and the ICV solenoid 160, 460. Moreover, the ECM can control the supply of an electrical current to the ICV solenoid 160, 460 and/or the NCV solenoid 140, 440 that is used to control the opening and closing of a valve, such as a poppet valve, that is used to control the ingress and egress of fuel in at least portions of fuel injector.

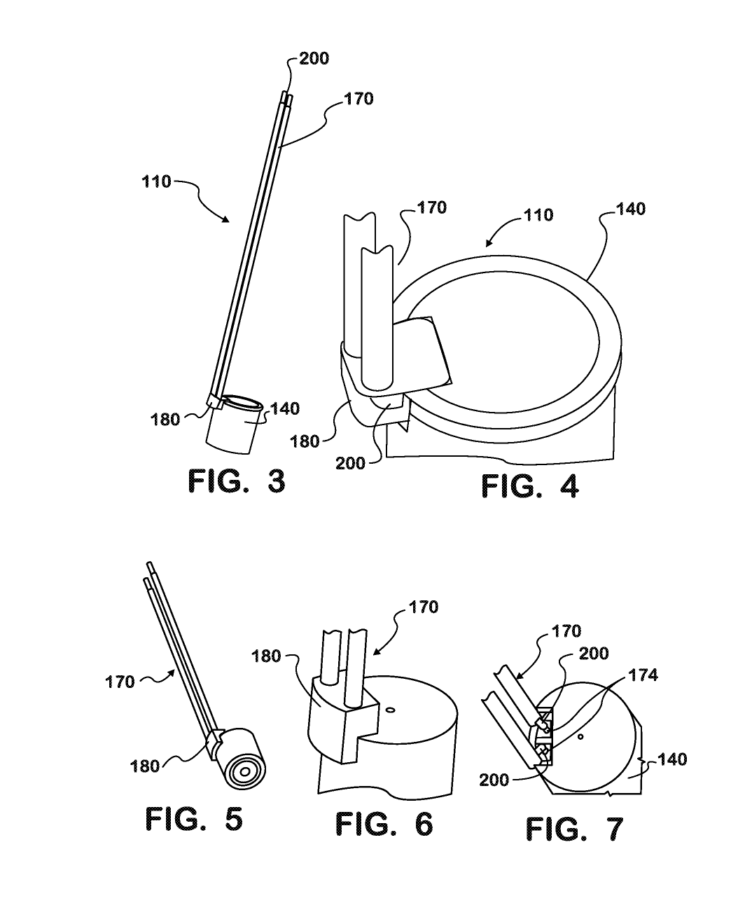

FIGS. 3-7 further illustrate the NCV solenoid assembly 110. In some embodiments, the NCV solenoid assembly 110 is an integrated configuration that combines the NCV solenoid 140 and a first pair of electrical rods 170. The first pair of electrical rods 170 includes a conductive material 200, at least a portion of which is surrounded by an insulation material 210. As shown in FIG. 7, the conductive material 200 from the first pair of electrical rods 170 may be connected to sockets 174 in the NCV solenoid 140. Further, according to certain embodiments, the conductive material 200 may be soldered to the NCV solenoid 140. The first pair of electrical rods 170 is integrated by an overmold 180 and the attachment of the overmold 180 to the NCV solenoid 140. As illustrated by FIGS. 4 and 6, the overmold 180 may allow the first pair of electrical rods 170 to be overhung or offset from the NCV solenoid 140 by different distances, which may assist in addressing packaging restraints within the fuel injector. The overmold 180 may also be configured to at least assist in preventing the exposure of the conductive material 200 and sockets 174, and thereby prevent electrical shorts at the NCV solenoid 140.

According to certain embodiments, the first pair of electrical rods 170 can reach to the top of the terminal assembly 130 for final termination. This configuration effectively reduces the number of electrical connections that have to be made on an assembly line, for example.

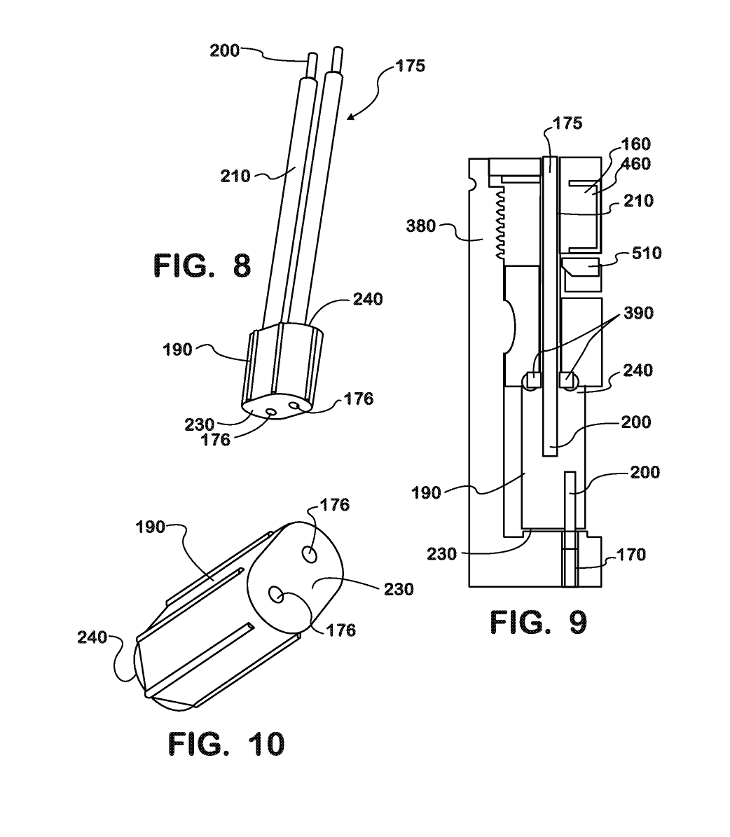

FIGS. 8-10 illustrate different embodiments of a connector bridge 190 for the NCV solenoid sub-assembly 150. The connector bridge 190 is a one-piece configuration for the termination of the first pair of electrical rods 170 from the NCV solenoid assembly 110 and a second pair of electrical rods 175 from the terminal assembly 130, 430. Moreover, the connector bridge 190 provides a pathway that allows electrical current to flow between the first and second pair of electrical rods 170, 175. As shown in FIGS. 8 and 10, the connector bridge 190 includes a first interface 230 and a second interface 240 that may have pair of sockets 176 that are configured to receive a portion of the conductive material 200 from the first and second pairs of electrical rods 170, 175. FIG. 8 illustrates an embodiment of the connector bridge in which the second pair of electrical rods 175 is integrated into the connector bridge 190, such as, for example, being soldered or welded to one or more sockets 176 in the connector bridge 190. However, according to other embodiments, the second pair of electrical rods 175 may be configured to be inserted into the connector bridge 190 during assembly of the fuel injector. For example, in the embodiment illustrated in FIG. 10, the second pair of electrical rods 175 may part of, or operably connected to, the terminal assembly 130, such as, for example, by soldering. According to such an embodiment, the second pair of electrical rods 175 may be operably received by the sockets 176 along the second interface 240 of the connector bridge 190 during fuel injector assembly.

Referencing FIG. 9, the first interface 230 interfaces with the first pair of electrical rods 170, while the second interface 240 interfaces with a second pair of electrical rods 175. In some embodiments, the sockets 176 of the first interface 230 of the connector bridge 190 is on an opposite side and offset with respect to the sockets 176 of the second interface 240. The resulting offset between the first and second pairs of electrical rods 170, 175 may be configured to address possible packaging constraints inside the fuel injector that may otherwise prevent a straight electrical rod 170 from extending between the terminal assembly 130, 430 and the NCV solenoid 140, 440 in the fuel injector body 380. Additionally, according to certain embodiments, at least one interface, such as the first interface 230 for example, may abut against a seal 390 that at least attempts to prevent fuel from entering into the connector bridge 190. In the embodiment illustrated in FIG. 9, the connector bridge 190 may be positioned beneath the armature 510 of the poppet valve that is operated by the ICV solenoid 160, 460.

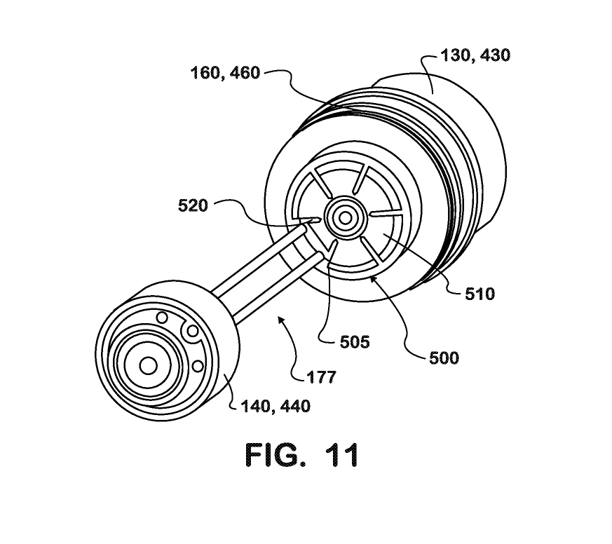

According to another embodiment, the ICV solenoid 160, 460 and the associated poppet valve 500 may be configured to provide an offset that allows for an in-line connection using a pair of electrical rods 177 from the terminal assembly 130, 430 to the NCV solenoid 140, 440. For example, as shown in FIG. 11, the pair of electrical rods 177 may exit an inward section of the ICV solenoid 160, 460, such as, for example one or more apertures 505 in a solenoid material of the ICV solenoid 160, 460. Further, according to certain embodiments in which the valve 500 is a poppet valve, the armature 510 of the valve 500 may have a slot 520 that is configured to receive at least a portion of the electrical rods 177 while the armature 510 is still able to be displaced between an open and closed position by actuation of the ICV solenoid 160, 460.

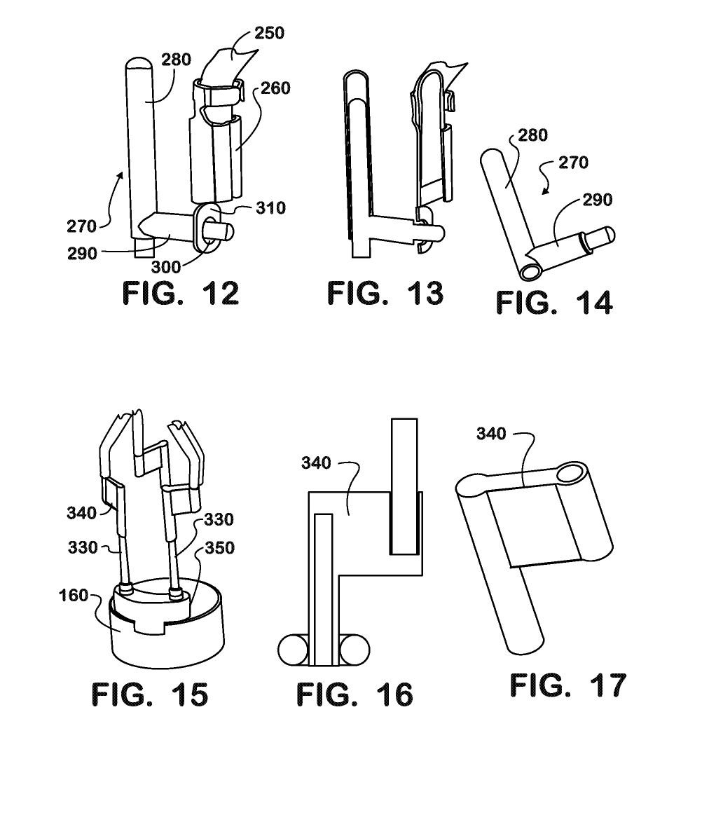

FIGS. 12-14 illustrate connectors of the terminal assembly 130. FIG. 7A illustrates that one of the four wire cables 250 is held by and electrically connected to a wire cable post 260. At least one of the four wire cables 250 can be in electrical communication with the ECM, for example. The wire cable post 260 is soldered to a connector 270. The connector 270 can have to a first post 280 and a second post 290 that are integral and perpendicular. The tip of the second post 290 is configured to accommodate an aperture 300 in a terminal 310 of the wire cable post 260. The connector 270 can also have an interface 320 that interfaces with an electrical rod 330.

Referring to FIGS. 15-17, in one embodiment, the connector 270, the wire cable post 260 and a portion of the wire cable 250 can be overmolded into a connector 340. In another embodiment, the wire cables 250 are inserted into the connector 340 such that they are electrically connected to the connector 340.

Each of the four wire cables 250 in electrical communication with the ECM terminates at the respective connector 340 of the terminal assembly 130. The connectors 340 provide the electrical connection between the ECM and the solenoids (e.g., the ICV solenoid 160 and the NCV solenoid 140). In the connector 340, the interface with the wire cable 250 and the interface with the electrical rod 330 are offset and/or integrated. Two electrical rods 330 connect the connectors 340 to another connector 350. In some embodiments, the connector 350 may provide an integrated connection between two of the wire cables 250, which are in electrical communication with the ECM, and the ICV solenoid 160.

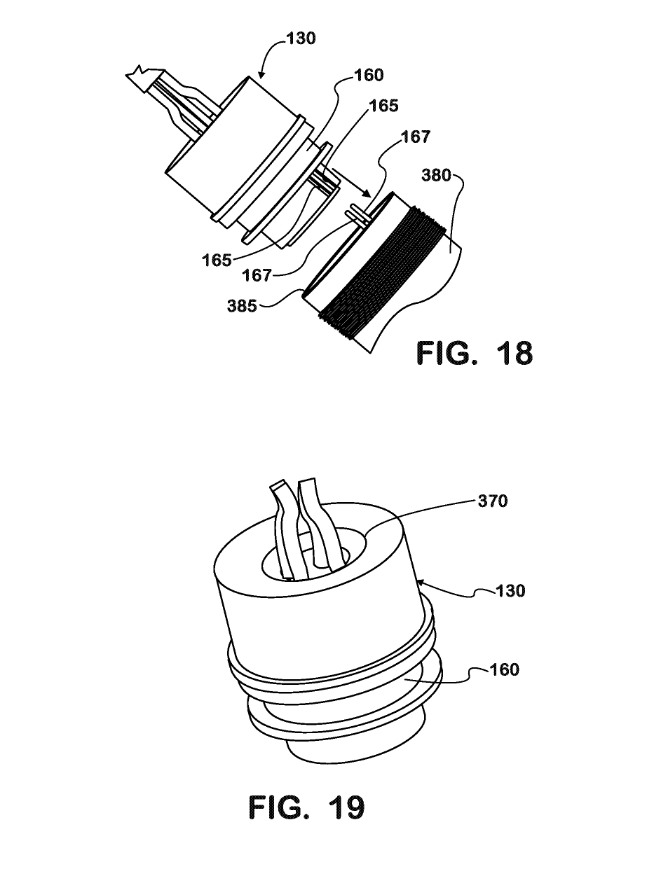

Referring to FIGS. 18 and 19, the connectors 340 can be overmolded into the terminal assembly 130. The four wire cables 250 terminate in a quick-connect connector 360 illustrated in FIG. 1. The quick-connect connector 360 connects with, for example, a particular wiring harness for use with an engine platform (e.g., the Navistar 16 engine platform).

FIG. 18 also shows that the connector bridge 190 configuration in FIGS. 8-10 allows for easy assembly of the top terminal into the injector body without the use of index features. The connector bridge 190 configuration simplifies manufacturing and the assembly process. As illustrated in FIG. 11, according to certain embodiments, the ICV solenoid 160 may include one or more grooves 165 that are configured to mate with one or more projections 167, such as, for example, rods, that extends from an upper surface 385 of the injector body 380. Such a mating engagement between the grooves 165 and projections 167 may assist in the guiding the placement of the solenoid and terminal assembly 100 in the fuel injector 380 during assembly.

Referring to FIG. 19, the overmold of the terminal assembly 130 includes a radius profile 370. The radius profile on the overmold reduces or eliminates excessive bending of pigtail wires in any direction. The radius profile thus is configured to prevent failures due to pinching of the wires.

Referencing FIGS. 2, 20 and 21, according to certain embodiments, the second pair of electrical rods 175 as well as the ICV electrical rods 178 may each terminate at the terminal assembly 430 at a terminal stud 435. The ICV electrical rods 178 may also include conductive material 200 and insulation material 210, and are configured to deliver electrical current to the ICV solenoid 460. According to certain embodiments, the electrical rods 175, 178 may be soldered to the terminal studs 435. The ICV electrical rods 178 may also be soldered to the ICV solenoid 460. According to certain embodiments, the terminal stud 435 may include a threaded connector that allows for the wires 470 to be operably secured to the terminal stud 435 through the use of captured nuts 475.

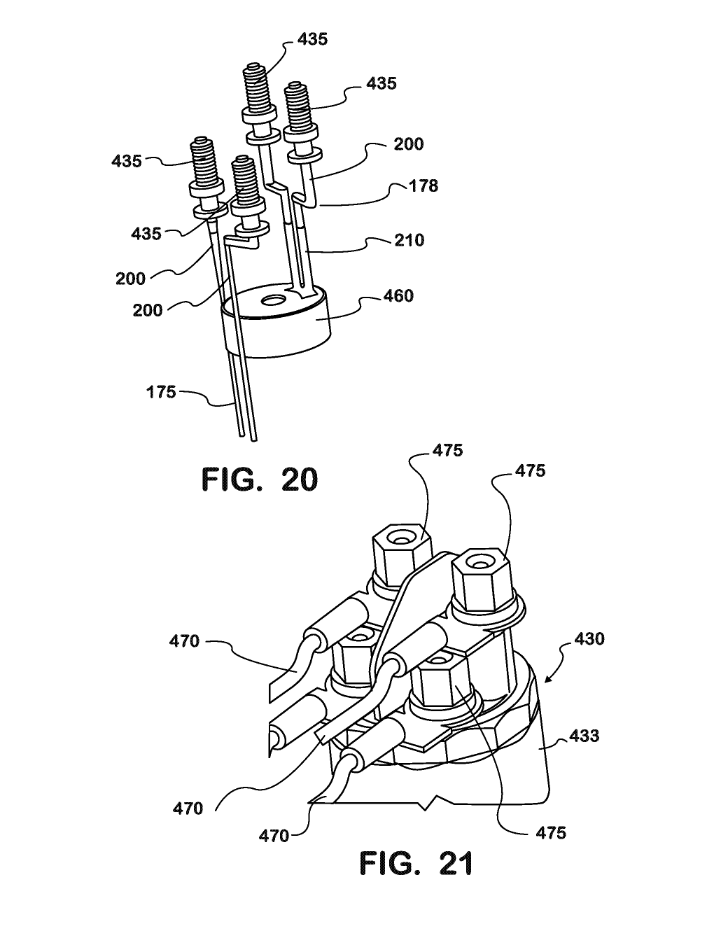

As also shown in FIGS. 2, 20, and 21, the terminal studs 435 for the first pair of electrical connectors 175 may be at a lower height, or staggered from, the terminal studs 435 for the ICV electrical rods 178. Such as staggered configuration may assist in the placement and/or securing of the wires 470 and captured nuts 475 to the terminal studs 435. Further, such a staggered configuration may accommodate the configuration or pattern of the wiring harness associated with the wires 470 that are connected to the terminal assembly 430. As shown by at least in FIGS. 2 and 21, the terminal assembly 430 includes an overmold 433 that covers at least a portion of the second pair of electrical rods 175 and the ICV electrical rods 178 shown in FIG. 20.

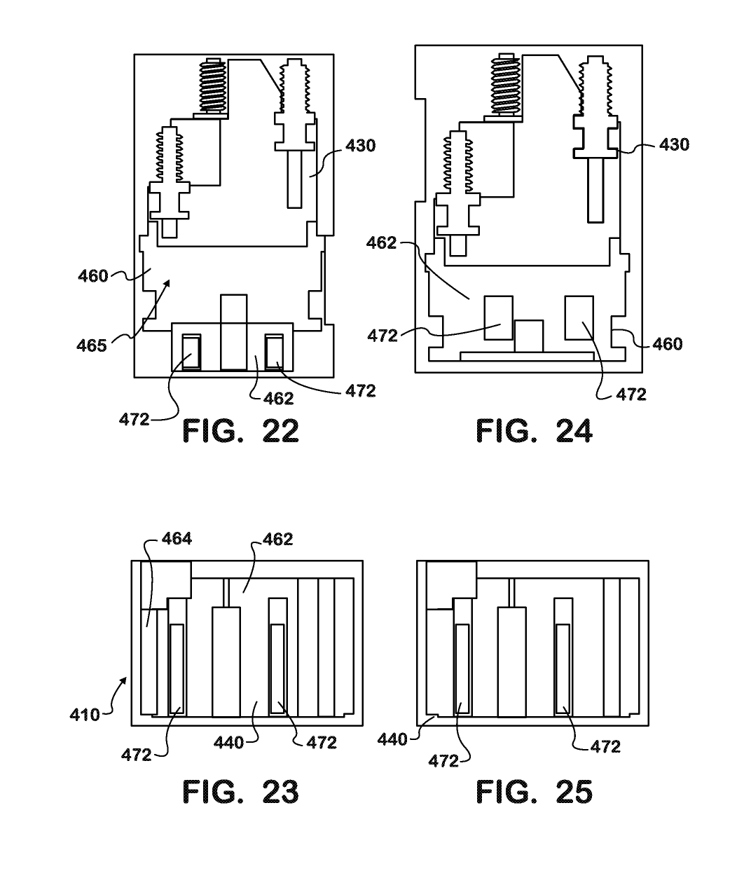

FIGS. 22 and 23 illustrate an ICV solenoid 460 that is attached to the terminal assembly 430 and a NCV solenoid 440 that is housed in the pole cage assembly 410, respectively. As shown, the ICV solenoid 460 and the NCV solenoid 440 include a solenoid material 462 and a solenoid housing 464, 465. The solenoid material 462 may be placed around at least a portion of a coil 472, such as wound copper coil, that receives an electrical current that is used with the solenoid material to attract an armature of the associated poppet valve. For example, referencing FIG. 22, electrical current flowing through the coil 472 associated with the ICV solenoid 460 may be used with the solenoid material 462 to attract the armature 510 of the associated poppet valve, as previously discussed with respect to at least FIG. 9.

According to certain constructions, the solenoid material 482 is pressed fitted into the solenoid housings 464, 465 of the NCV solenoid 440 and the ICV solenoid 460, respectively, or a portion thereof. In such constructions, the size of the solenoid housing 464, 465 may reduce the available space for the solenoid material 462. Yet, the solenoid material 462 must still have the ability to assist in pulling, when required, the armature toward the associated solenoid, such as the ICV solenoid 160, 460 or the NCV solenoid 140, 440. Therefore, a decrease in available area for the solenoid material 462 may require the use of solenoid material 462 having higher pulling properties than other solenoid materials. Moreover, by reducing the size of the solenoid housing 464, 465, an alternative solenoid material 462 may need to be used that may still attain the needed attractive forces while using less solenoid material 462. However, typically, not all solenoid materials have the same attraction or pulling capacities. Yet, such properties may increase the cost of the solenoid material 462. For example, according to some devices, a reduction in the area available for solenoid material 462 may require the use of AFK502/Vacolflux50 as the solenoid material. However, AFK502/Vacolflux50 is relatively expensive and may have relatively long lead times in procuring.

FIGS. 24 and 25 illustrate an embodiment in which the portions of the ICV solenoid 460 and NCV solenoid 440 shown in FIGS. 22 and 23, respectively, such as the solenoid housings 464, 465, have been constructed with solenoid material 462. By using solenoid material 462 for components of the solenoids 440, 460 that had not previously been constructed from solenoid material 462, the size of the solenoid material 462 is increased. Such an increase may allow for the use of less expensive and more commonly available solenoid material 462, as more solenoid material 462 may be used to the achieve the desired force to attract the armature 510. For example, according to certain embodiments, the solenoid material 462 and the solenoid housings 464, 465 as shown in FIGS. 22 and 23 may be constructed from 4140 steel grade. By constructing the solenoid housings 464, 465 with the same material as the solenoid material 462, the quantity of solenoid material is increased. This increase in quantity may allow for the use of solenoid materials 462 having lower attraction properties and/or capabilities. Moreover, in larger quantities, such solenoid materials 462 may be able to achieve the required pulling force on the poppet armature. Additionally, with respect to FIG. 24, the pulling or attraction force used to attract the poppet to the ICV solenoid 460 may be further increased or supplemented by constructing a terminal housing 466 of the terminal assembly 430 from solenoid material 462 used to construct the ICV solenoid 460 and the ICV solenoid housing 464.

Some embodiments provide for a one-piece connector bridge with offset features.

Some embodiments provide for a slot in an armature of a poppet valve associated with an intensifier control valve solenoid for receipt of electrical rods used to deliver electrical current to a needle control valve intensifier.

Some embodiments provide for a solenoid having an increased number of components constructed from a solenoid material.

Some embodiments provide for connector configurations that include perpendicular features that allow for a reduced packaging envelope.

Some embodiments provide for a terminal assembly configuration that prevents wire pinch, thereby preventing failures.

The various connectors described herein help in reducing the packaging envelope and/or assist with the centering or positioning of the cable wires that allow for flexible wire harness positioning.

1. A terminal assembly in a fuel injector, comprising:
a connector that electrically connects a plurality of wire cables to a plurality of control valve solenoids,
wherein the connector is configured with a radius profile, and
wherein the radius profile prevents excessive bending of the wire cables.

2. The terminal assembly of claim 1, wherein each of the plurality of wire cables is held and electrically contacted with a respective wire cable post, and wherein the respective wire cable post is electrically connected to a respective second connector.

3. The terminal assembly of claim 2, wherein the respective second connector and the respective wire cable post are overmolded into a third connector.

4. The terminal assembly of claim 4, wherein the third connector has electrical interfaces on opposite sides that are offset.

5. A fuel injector assembly, comprising:
a terminal assembly that electrically connects a plurality of wire cables to a plurality of control valve solenoids, wherein the terminal assembly is configured with a radius profile, and wherein the radius profile prevents excessive bending of the wire cables.

6. The fuel injector assembly of claim 5, comprising:
an intensifier control valve solenoid coupled to the terminal assembly, wherein the intensifier control valve is electrically coupled to at least two of the plurality of wire cables through the terminal assembly.

7. The fuel injector assembly of claim 5, comprising:
a needle control valve solenoid coupled to the terminal assembly, wherein the needle control valve is electrically coupled to at least two of the plurality of wire cables through the terminal assembly; and
a connector bridge configured with a first electrical interface on an opposite side and offset from a second electrical interface, wherein the first electrical interface receives a plurality of electrical rods from the needle control valve solenoid.

8. The fuel injector assembly of claim 9, wherein the second electrical interface of the connector bridge receives another plurality of electrical rods, wherein the another plurality of electrical rods physically or electrically connect with an intensifier control valve solenoid or the terminal assembly.

9. A fuel injector assembly, comprising:
a terminal assembly having a first pair of terminal studs and a second pair of terminal studs;
an intensifier control valve solenoid;
a pair of intensifier control valve electrical rods that terminate at the first pair of terminal studs, the pair of intensifier control valve electrical rods configured to deliver electrical current to the intensifier control valve solenoid;
a first pair and a second pair of electrical rods electrically coupled together by a connector bridge, the connector bridge configured to offset the first pair electrical rods from the second pair of electrical rods, the second pair of electrical rods being configured to terminate at the second pair of terminal studs; and
a needle control valve solenoid, the first pair of electrical rods being configured to terminate at the needle control valve solenoid.

10. The fuel injector assembly of claim 9, wherein the terminal assembly includes an overmolded material on the intensifier control valve solenoid.

11. The fuel injector assembly of claim 9, wherein the first pair of terminal studs is staggered from the second pair of terminal studs.

12. The fuel injector assembly of claim 11, wherein a solenoid housing of the intensifier control valve solenoid is constructed from a solenoid material.

13. A fuel injector assembly, comprising:
a pair of electrical rods configured to deliver an electrical current to a needle control valve solenoid;
an intensifier control valve solenoid having a solenoid material, the solenoid material configured to allow at least a portion of the pair of electrical material rods to pass through the solenoid material; and
a poppet valve having an armature, the armature configured to be moved between an open position and a closed position by actuation of the intensifier control valve solenoid, the armature including a slot configured to receive at least a portion of the pair of electrical rods.

14. The fuel injector assembly of claim 9, wherein a solenoid housing of the intensifier control valve solenoid is constructed from a solenoid material.

15. A method for terminating a solenoid in a fuel injection assembly, comprising:
electrically connecting first ends of a plurality of electrical rods with first interfaces of a connector bridge;
electrically connecting second ends of the plurality of electrical rods to the solenoid;
offsetting second interfaces of the connector bridge, the offset second interfaces being disposed on an opposite side of the connector bridge as the first interfaces;
electrically connecting the second interfaces of the connector bridge to a terminal assembly; and
providing a radius profile at one end of the terminal assembly to prevent excessive bending of the cable wires that are electrically connected to the terminal assembly.
